(19) United States
(12) Patent Application Publication
(10) Pub. No.: US 2012/0126034 A1
(43) Pub. Date: May 24, 2012

(54) Impingement Mixing Liquid Dispensing Apparatus and Methods

(76) Inventors: Darren Edward Nolen, Atlanta, GA (US); Olivia Andromeda Nolen-Carr, Atlanta, GA (US)

(21) Appl. No.: 13/293,101

(22) Filed: Nov. 9, 2011

Related U.S. Application Data
(60) Provisional application No. 61/416,321, filed on Nov. 23, 2010.

(51) Int. Cl. A62C 31/00; F23D 14/28

(52) U.S. Cl. 239/443; 239/337; 222/135

(57) ABSTRACT

The invention comprises two or more nozzle outlets, oriented so as to dispense liquid streams on convergent paths. The convergent steams, upon impingement one with the other, mix external to the nozzle, the mixed liquids thereafter proceeding to the target surface. Feeding the convergent nozzle outlets are independent fluid pathways, consisting either of a pump and reservoir for each fluid, or of a valve and pressurized reservoir for each fluid for self-dispensing embodiments. The fluid pathways are particularly designed so as to maintain the liquids in fluid isolation, one from the other, until the impingement mixing external to the nozzle. Also included within the invention are methods of dispensing immiscible and reactive liquids, in particular an embodiment for dispensing an edible oil and vinegar mixture and an embodiment for dispensing and forming a tissue sealant.

### CROSS-REFERENCE TO RELATED APPLICATIONS

This application is related to Provisional Patent Application No. 61/416,321 and claims priority therein.

### STATEMENT REGARDING FEDERALLY SPONSORED RESEARCH OR DEVELOPMENT

No support or compensation has been received for work in support of this invention. The Federally Sponsored Research provision is not applicable.

### THE NAMES OF PARTIES TO A JOINT RESEARCH AGREEMENT

None

### BACKGROUND OF THE INVENTION

1. Field of the Invention

The field of the invention is the simultaneous dispensing and mixing of plural liquids.

2. Description of the Prior Art

An aerosol dispensing container for simultaneously dispensing two liquids is described in Homm (U.S. Pat. No. 2,941,696). The liquids are held in separate reservoirs prior to being dispensed into a common exit, then laterally from the spray head. In an unclaimed embodiment, separate nozzles are described dispensing the two liquids as parallel aerosol sprays, again laterally from the spray head.

An industrial spray gun for simultaneously dispensing two liquids is described in Barrett (U.S. Pat. No. 2,813,751). The spray gun provides for separate liquid pathways from external reservoirs with dispensing and aerosolization by means of an external compressed air supply. The aerosolized sprays are projected on a laterally convergent path, with a degree of mixing external to the device.

A toy water gun is disclosed in Eddins, et. al (U.S. Pat. No. 7,798,364). The gun maintains two liquids in separate reservoirs with separate liquid pathways and separate nozzle orifices that may be oriented to dispense liquid streams on a convergent path. Also described is a method of dispensing reactive liquids, the reaction of which occurs external to the nozzle orifices.

A low volume mixing spray head is disclosed in Duronio, et. al (U.S. Pat. No. 6,328,229). The described devices discharges two liquid streams within a common mixing chamber prior to the mixed liquids projecting towards the target surface.

### BRIEF SUMMARY OF THE INVENTION

The present invention is, in a first aspect, a self-contained liquid dispensing apparatus for discharging and mixing a first liquid and a second liquid by means of pressure derived from a propellant gas. The apparatus may include a first reservoir configured to store the first liquid and a propellant gas, a second reservoir configured to store the second liquid and a propellant gas, a nozzle having a first nozzle inlet in fluid communication with the first reservoir and a first nozzle outlet, and a second nozzle inlet in fluid communication with the second reservoir and at least two second nozzle outlets. The apparatus may further include a first valve disposed between the first reservoir and the first nozzle inlet, the first valve having a closed position wherein the first reservoir is not in fluid communication with the first nozzle inlet, and an open position wherein the first reservoir is in fluid communication with the first nozzle inlet. The apparatus may still further include a second valve disposed between the second reservoir and the second nozzle inlet, the second valve having a closed position wherein the second reservoir is not in fluid communication with the second nozzle inlet, and an open position wherein the second reservoir is in fluid communication with the second nozzle inlet.

The second nozzle outlets may be radially configured about the first nozzle outlet and oriented such that the second discharge streams impinge upon the first discharge stream after being discharged from the nozzle.

The nozzle may be further configured such that the second discharge streams from the second nozzle outlets impinge upon the first discharge stream at an acute angle.

The first and second reservoirs of the embodiment may further comprise a non-slip coating upon the outer surface. This will prove useful in situations in which the apparatus may become wet or be held with wet hands, such as would occur during surgery.

The apparatus may also comprise a mechanism to introduce atmospheric air as a propellant gas into the first and second reservoirs. This will be useful in the dispensing and mixing of edible liquids, where the user may fill the reservoirs with liquid and subsequently pressurize them for dispensing.

The apparatus may also comprise an activation mechanism operatively coupled to the first valve and the second valve, moving the first valve and second valves simultaneously from the closed to the open position when moved from a normal position to a discharge position.

In another aspect, the invention is also a self-contained liquid dispensing apparatus for discharging and mixing a first liquid and a second liquid by means of pressure derived from a pressurization mechanism. The apparatus may include a first reservoir configured to store the first liquid, a second reservoir configured to store the second liquid, a nozzle having a first nozzle inlet in fluid communication with the first reservoir and a first nozzle outlet, and a second nozzle inlet in fluid communication with the second reservoir and at least two second nozzle outlets. The apparatus may further include a first pressurization mechanism in fluid communication with the first reservoir, wherein the pressurization mechanism provides pressure to cause the first liquid from the first reservoir to be discharged from the first nozzle outlet in a first discharge stream. The apparatus may still further include a second pressurization mechanism in fluid communication with the second reservoir, wherein the pressurization mechanism provides pressure to cause the second liquid from the second reservoir to be discharged from the second nozzle outlets in at least two second discharge streams.

The second nozzle outlets may be radially configured about the first nozzle outlet and oriented such that the second discharge streams impinge upon the first discharge stream after being discharged from the nozzle.

The nozzle may be further configured such that the second discharge streams from the second nozzle outlets impinge upon the first discharge stream at an acute angle.

The apparatus may also comprise an activation mechanism operatively coupled to the first pressurization mechanism and the second pressurization mechanism, providing pressure to the first liquid and the second liquid simultaneously when moved from a normal position to a discharge position.

In a further aspect, the invention is directed to a method for discharging and mixing a first liquid and a second liquid from a self-contained apparatus. The method may include providing a nozzle with a first nozzle outlet for discharging the first liquid and a second nozzle outlets for discharging the second liquid from the apparatus, aligning the first nozzle outlet and the second nozzle outlets such that discharged streams of the second liquid impinge upon the discharged stream of the first liquid. The method may further include storing a quantity of the first liquid and a quantity of the second liquid in the apparatus and simultaneously supplying the stored first liquid to the first nozzle inlet and the stored second liquid to the second nozzle inlet under pressure for discharge from the first nozzle outlet and the second nozzle outlets, respectively.

The method may include the dispensing and mixing of a liquid comprising an edible oil and a liquid comprising an aqueous solution.

The method may include the dispensing and mixing of a liquid comprising olive oil and a liquid comprising vinegar.

The method may include the dispensing and mixing of a liquid comprising a polysaccharide and a liquid comprising a polysaccharide cross-linking agent.

The method may include the dispensing and mixing of a liquid comprising alginate and a liquid comprising calcium chloride.

The method may include the dispensing and mixing of a liquid comprising chitosan and a liquid comprising tripolyphosphate.

The method may include the dispensing and mixing of a liquid comprising an aqueous protein solution and a liquid comprising a protein cross-linking agent.

The method may include the dispensing and mixing of a liquid comprising an aqueous albumin solution and a liquid comprising aldehyde.

The method may include the dispensing and mixing of a liquid comprising a blowing agent and a liquid comprising an acid reactable on contact with the blowing agent sufficient to evolve a gas. The blowing agent may comprise a carbonate.

The method may include the dispensing and mixing of a liquid comprising fibrinogen and a liquid comprising thrombin.

### BRIEF DESCRIPTION OF THE SEVERAL VIEWS OF THE DRAWING

Features of the invention, its nature and various advantages will be apparent from the accompanying drawings and the following detailed description of various embodiments, in which:

FIG. 1 is a front view of a dispensing apparatus in accordance with the invention;

FIG. 2 is an enlarged detail view of area 2 of the nozzle and the first and second nozzle outlets of the apparatus of FIG. 1;

FIG. 3 is a perspective view of the apparatus of FIG. 1;

FIG. 4 is a side view of the apparatus of FIG. 1;

FIG. 5 is a cross-sectional view through line 4-4 of FIG. 4 showing the interior of the apparatus;

FIG. 6 is a perspective view of the discharge head and nozzle of the apparatus of FIG. 1;

FIG. 7 is a front view of the discharge head and nozzle of the apparatus of FIG. 1;

FIG. 8 is a cross-sectional view through line 6-6 of FIG. 7 showing the interior of the discharge head and nozzle;

FIG. 9 is a perspective view of the under portion of the discharge head and nozzle of the apparatus of FIG. 1;

FIG. 10 is a top view of the discharge head and nozzle of the apparatus of FIG. 1;

FIG. 11 is a cross-section view through line 8-8 of FIG. 10 showing the interior of the discharge head;

FIG. 12 is a front view of the discharge head and nozzle of the apparatus of FIG. 1;

FIG. 13 is a cross-section view through line 10-10 of FIG. 12 showing the interior of the discharge head and nozzle;

FIG. 14 is a perspective of an alternate embodiment of the apparatus;

FIG. 15 is an enlarged detail view of area 12 of the nozzle and the first and second nozzle outlets of the apparatus of FIG. 14;

FIG. 16 is a front view of the apparatus of FIG. 14;

FIG. 17 is a cross-section view through line 14-14 of FIG. 16 showing the interior of the reservoirs, inlets, nozzle, and outlets of the apparatus of FIG. 14;

FIG. 18 is an enlarged detail view of area 16 of the nozzle, first and second nozzle inlets, and the first and second nozzle outlets of the apparatus of FIG. 14;

FIG. 19 is a perspective of an alternate embodiment of the apparatus;

FIG. 20 is an enlarged detail view of area 18 of the nozzle and the first and second nozzle outlets of the apparatus of FIG. 19;

FIG. 21 is a front view of the apparatus of FIG. 19;

FIG. 22 is a cross-section view through line 20-20 of FIG. 21 showing the interior of the discharge head, nozzle, inlets, and outlets;

FIG. 23 is a top view of the apparatus of FIG. 19;

FIG. 24 is a cross-section view through line 22-22 of FIG. 23 showing the interior of the reservoirs, pressurization mechanisms, and discharge head;

### DETAILED DESCRIPTION OF THE INVENTION

### Field of the Invention

The field of the invention is the simultaneous dispensing and mixing of plural liquids.

### Description of the Invention

Although the following text sets forth a detailed description of numerous embodiments of the invention, it shall be understood that the scope of the invention is defined by the claims set forth at the end of the patent. The detailed description is to be construed as exemplary only and does not describe every possible embodiment of the invention. Numerous alternative embodiments could be implemented, using current technology or technology developed after the filing date of this patent, which would still fall within the scope the present invention.

As used herein, a nozzle is a device designed to control the direction and characteristics of a fluid flow as it exits an enclosed chamber or tube.

The present inventive apparatus and methods utilize impingement of plural discharged streams to affect mixing of liquids. Impingement is a simple and robust means of liquid mixing, yet the method has certain limitations wherein the current inventive description improves upon.

Where discharged streams converge and impinge, mixing occurs. The degree of mixing, the degree of atomization, and the resulting pattern of mixed liquid spray is determined by factors such as:
a. the relative amounts of each liquid discharged;
b. the density, viscosity, and cohesive properties of each liquid;
c. the velocity of the impinging streams;
d. the impingement angle; and
e. the number and orientation of the impinging streams.

The present invention is suited to the simultaneous dispensing and mixing of liquids with differing amounts, viscosities, densities, and other qualities while also providing a selection of mixing and aerosolization intensities and spray patterns. By projecting a first discharged stream from a centrally located nozzle outlet, and second discharge streams from nozzle outlets radially configured about the first nozzle outlet, differing amounts, viscosities, densities, and cohesions may be more easily accommodated. By varying the impingement angle, the numbers of nozzle outlets, and the sizes of said outlet, the apparatus may be easily configured. The present invention is particularly suited to the dispensing and mixing of immiscible liquids and chemically reactive liquids.

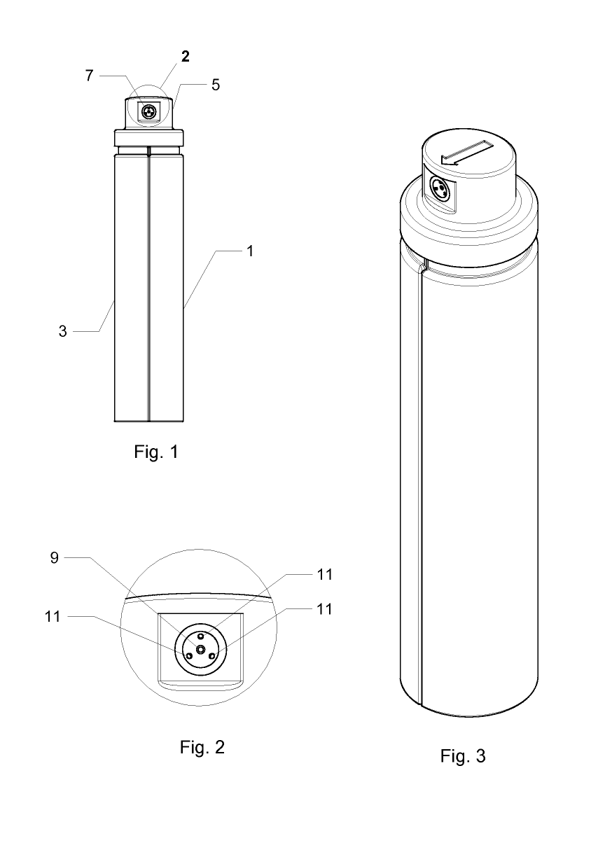

FIGS. 1-3 illustrate front, detailed, and perspective views, respectively, of a first embodiment of a liquid discharge and mixing apparatus intended for dispensing liquids by the means of stored propellant gas within the reservoirs and comprising a first reservoir 1 and a second reservoir 3, a discharge head 5 located adjacent to the first and second reservoirs, and a nozzle 7 coupled to the discharge head. The nozzle 7 comprises at least one first outlet 9 and at least two second outlets 11 configured radially about around the first outlet 9 and oriented such that liquid streams discharged from the second outlets (not shown) impinge upon the liquid stream from the first outlet (not shown).

It is envisioned that the nozzle may be fixed or subject to rotation by the user, that the nozzle may be integral to the discharge head or a separate entity coupled to the discharge head, and that the nozzle may comprise varying numbers and arrangements of first nozzle outlets and second nozzle outlets and still be considered to lay within the scope of the present invention so long as there is at least one first nozzle outlet and at least two second nozzle outlets arrayed radially about the first nozzle outlet. Incorporation of elements within the nozzle, nozzle inlets, and nozzle outlets to induce swirl in the discharged liquids is also envisioned.

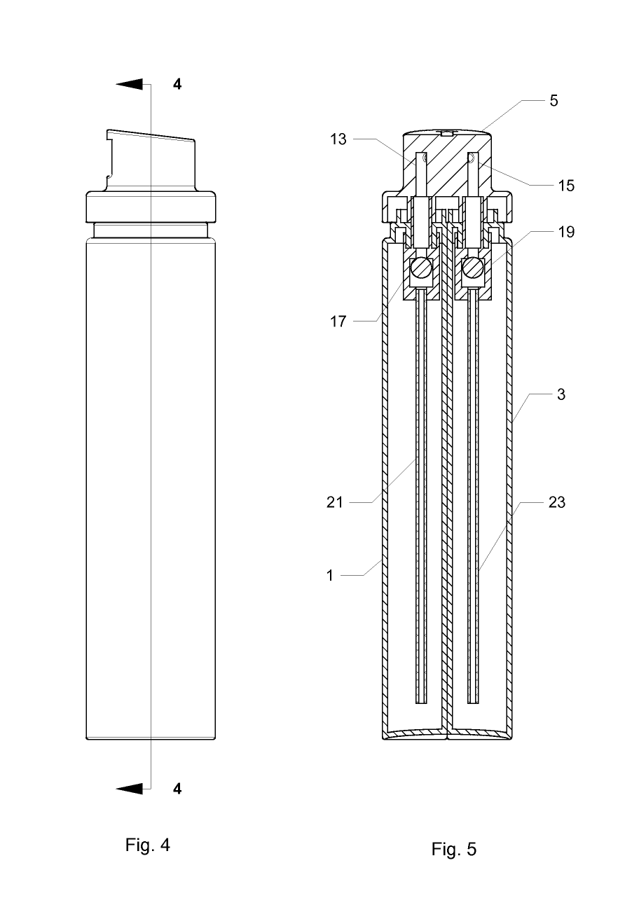

FIGS. 4 and 5 illustrate a side and section view, respectively, of the first embodiment comprising a first tube 21 within the first reservoir 1 in fluid communication with a first valve 17 and a first liquid passage 13 within the discharge head 5 and a second tube 23 within the second reservoir 3 in fluid communication with a first valve 19 and a first liquid passage 15 within the discharge head 5.

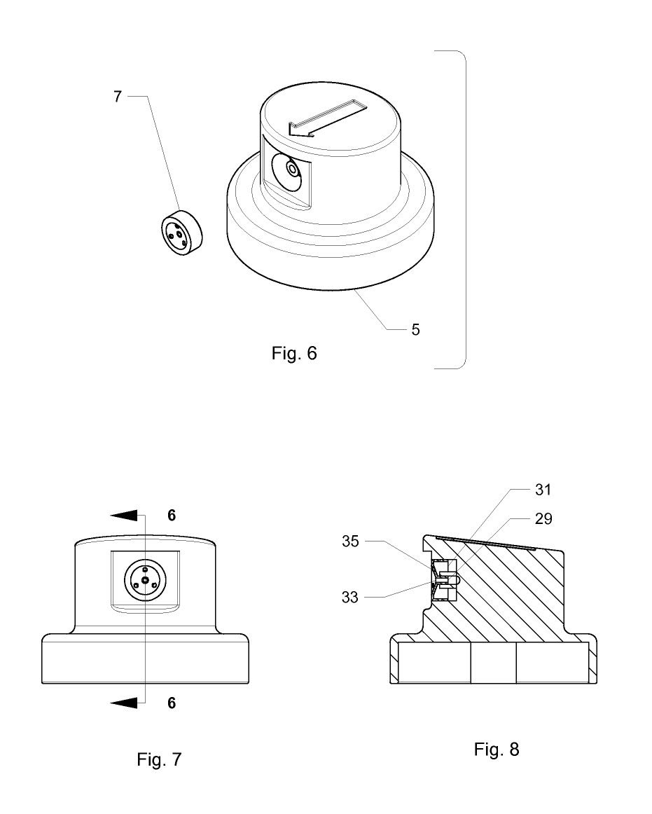

FIGS. 6-8 illustrate an exploded perspective, front, and side section view, respectively, of the discharge head for the first embodiment comprising a discharge head 5 and nozzle 7 wherein the nozzle 7 comprises a first inlet 29 in fluid communication with a first outlet 33 and a second inlet 31 in fluid communication with a second outlet 35.

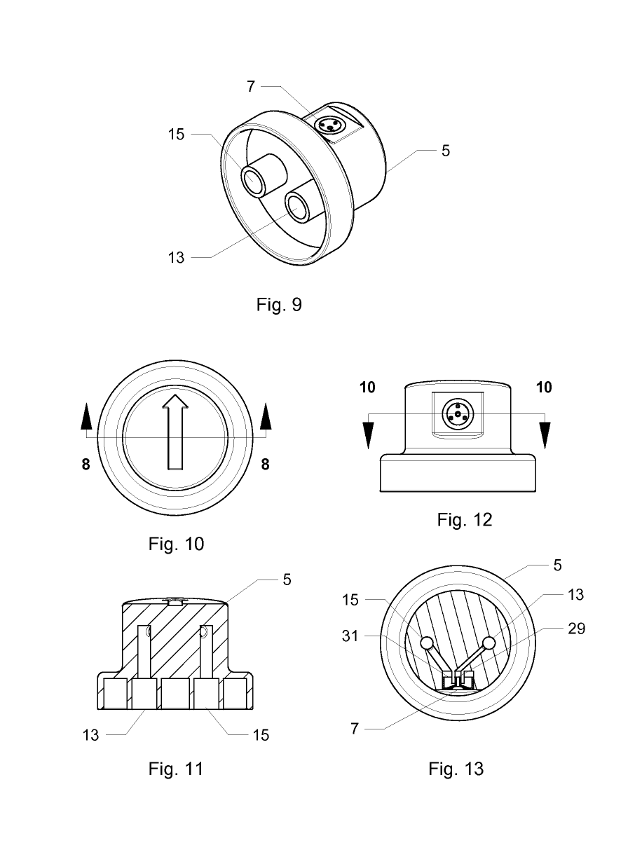

FIG. 9 illustrates a perspective view of the discharge head 5 of the first embodiment with the sockets of the first liquid pathway 13 and second liquid pathway 15 visible.

FIGS. 10 and 11 illustrate a top and section views, respectively, of the discharge head 5 with the first liquid pathway 13 and second liquid pathway 15 visible.

FIGS. 12 and 13 illustrate front and sections views, respectively, of the discharge head 5 revealing the first liquid pathway 13 in fluid communication with the first nozzle inlet 29 and the second liquid pathway 15 in fluid communication with the second nozzle inlet 31.

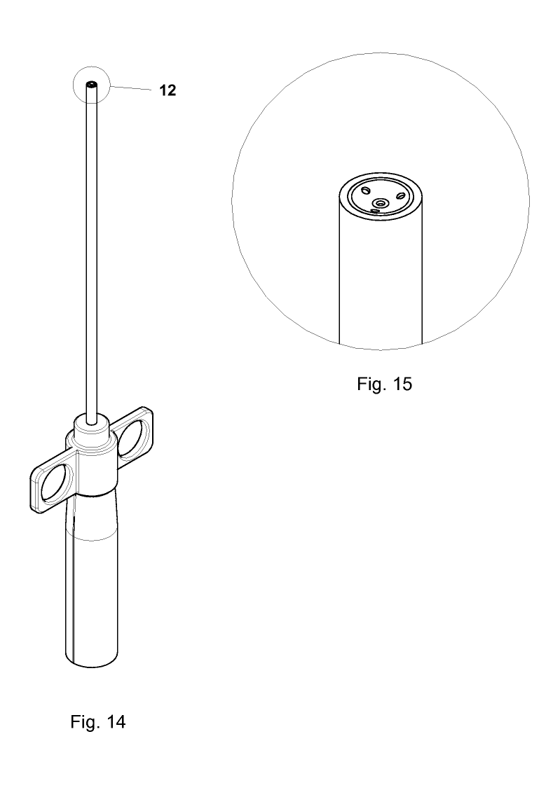

FIGS. 14 and 15 illustrate a perspective and enlarged detail view, respectively, of a second embodiment of the apparatus configured so as to be suitable for endoscopic use.

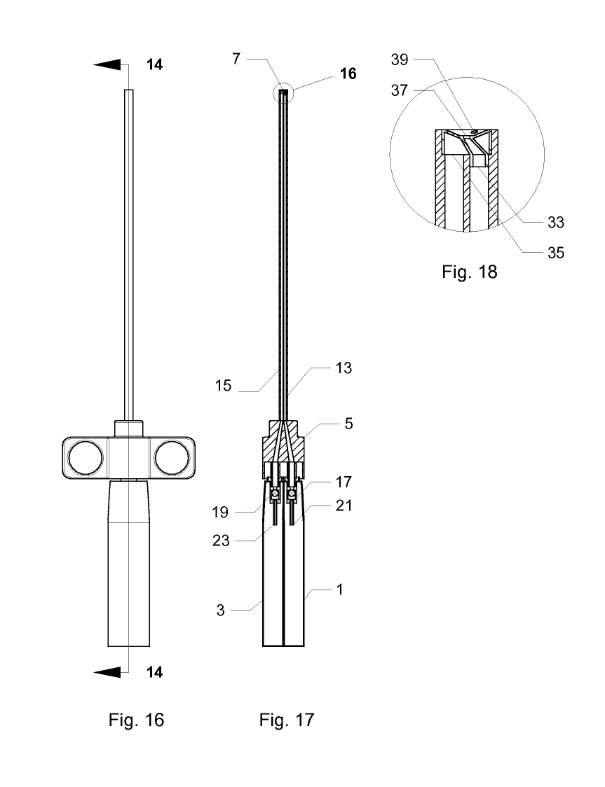

FIGS. 16 and 17 illustrate a side and section view of the second embodiment comprising a first tube 21 within the first reservoir 1 in fluid communication with a first valve 17 and a first liquid passage 13 and a second tube 23 within the second reservoir 3 in fluid communication with a second valve 19 and a second liquid passage 15, wherein the liquid pathways comprise an elongate member between the discharge head 5 and the nozzle 7.

FIG. 18 illustrates an enlarged detail section view of the second embodiment comprising a first liquid pathway 13 in fluid communication with a first nozzle inlet 29 and a first nozzle outlet 33 and a second liquid pathway 15 in fluid communication with a second nozzle inlet 31 and a second nozzle outlet 35.

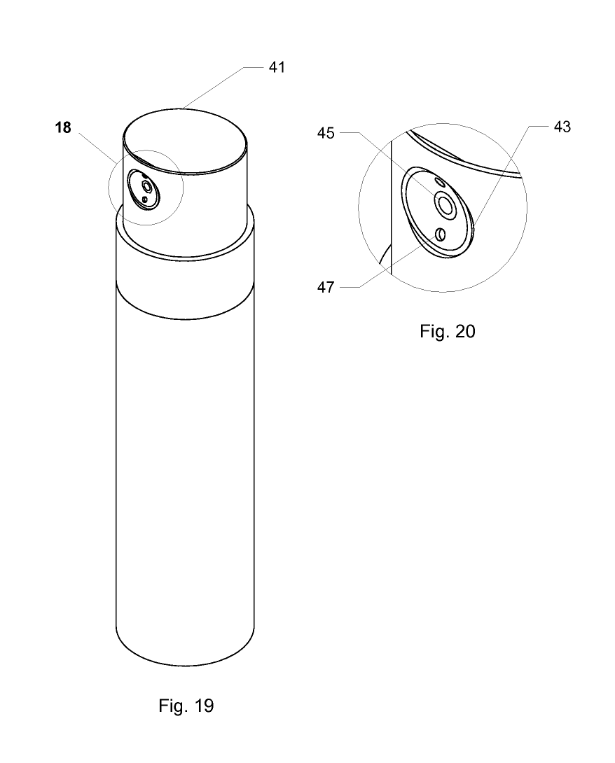

FIGS. 19 and 20 illustrate a perspective and enlarged detail view, respectively, of a third embodiment of the apparatus designed to utilize pressure generating mechanisms to dispense and mix the liquids. The embodiment comprises a discharge head 41 and a nozzle 43. The nozzle 43 comprises at least one first nozzle outlet 45 and at least two second nozzle outlets 47 arrayed around the first outlet 45 and oriented such that liquid streams discharged from the second outlets (not shown) impinge upon the liquid stream from the first outlet (not shown).

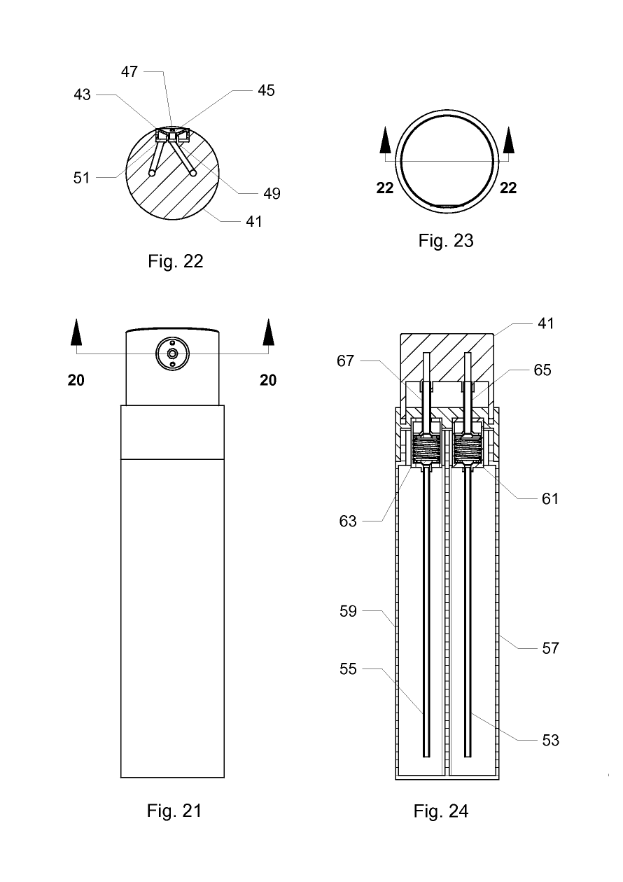

FIGS. 21 and 22 illustrate a front and section view, respectively, of the third embodiment comprising a discharge head 41, a nozzle 43, a first nozzle inlet 49 in fluid communication with a first nozzle outlet 45, and a second nozzle inlet 51 in fluid communication with a second nozzle outlet 47.

FIGS. 23 and 24 illustrate a top and section views, respectively, of the third embodiment comprising a first tube 53 within the first reservoir 57 in fluid communication with a first pressurization mechanism 61 and a first liquid passage 65 and a second tube 55 within the second reservoir 59 in fluid communication with a second pressurization mechanism 63 and a second liquid passage 67.

The dispensing methods are envisioned to operate from either the apparatus using integral pressurization mechanisms or the apparatus using stored propellant gas.

It is envisioned that the apparatus may be readily filled with liquids and/or propellant gas, depending upon the embodiment, by the manufacturer and delivered to the user. It is equally within the scope of the invention for the apparatus to be configured so as to readily permit the filling of liquids into the reservoirs by the user.

The embodiments illustrated herein are exemplary, and other configurations of dispensing apparatus wherein two or more liquids are stored in reservoirs, travel through separate fluid pathways, are discharged as impinging streams, and are mixed external to the apparatus are contemplated by the inventors and will be apparent to those skilled in the art. Specifically, differing numbers and configurations of first nozzle outlets and second nozzle outlets, differing configurations of activation mechanisms, and differing formulations of the liquids to be discharged are within the scope of the present invention.

1. A self-contained liquid dispensing apparatus for discharging and mixing a first liquid and a second liquid, comprising:
a. a first reservoir configured to store the first liquid and a propellant gas;
b. a second reservoir configured to store the second liquid and a propellant gas;
c. a nozzle having a first nozzle inlet in fluid communication with the first reservoir and a first nozzle outlet, and a second nozzle inlet in fluid communication with the second reservoir and at least two second nozzle outlets;
d. a first valve, disposed between the first reservoir and the first nozzle inlet, the first valve having a closed position wherein the first reservoir is not in fluid communication with the first nozzle inlet, and an open position wherein the first reservoir is in fluid communication with the first nozzle inlet; and
e. a second valve, disposed between the second reservoir and the second nozzle inlet, the second valve having a closed position wherein the second reservoir is not in fluid communication with the second nozzle inlet, and an open position wherein the second reservoir is in fluid communication with the second nozzle inlet,
wherein the second nozzle outlets are radially configured about the first nozzle outlet and oriented such that second discharge streams from the second nozzle outlets impinge upon a first discharge stream from the first nozzle outlet after being discharged from the nozzle.

2. An apparatus as in claim 1, wherein the second discharge streams from the second nozzle outlets impinge upon the first discharge stream from the first nozzle outlet at an acute angle.

3. A self-contained liquid dispensing apparatus for discharging and mixing a first liquid and a second liquid, comprising:
a. a first reservoir configured to store the first liquid;
b. a second reservoir configured to store the second liquid;
c. a nozzle having a first nozzle inlet in fluid communication with the first reservoir and a first nozzle outlet, and a second nozzle inlet in fluid communication with the second reservoir and at least two second nozzle outlets;
d. a first pressurization mechanism in fluid communication with the first reservoir, wherein the pressurization mechanism provides pressure to cause the first liquid from the first reservoir to be discharged from the first nozzle outlet in a first discharge stream; and
e. a second pressurization mechanism in fluid communication with the second reservoir, wherein the pressurization mechanism provides pressure to cause the second liquid from the second reservoir to be discharged from the second nozzle outlets in at least two second discharge streams,
wherein the second nozzle outlets are radially configured about the first nozzle outlet and oriented such that the second discharge streams impinge upon the first discharge stream after being discharged from the nozzle.

4. An apparatus as in claim 3, wherein the second discharge streams from the second nozzle outlets impinge upon the first discharge stream from the first nozzle outlet at an acute angle.

5. A method for discharging and mixing a first liquid and a second liquid from an apparatus, comprising:
a. providing a nozzle with a first nozzle outlet for discharging the first liquid from the apparatus and second nozzle outlets for discharging the second liquid from the apparatus;
b. aligning the first nozzle outlet and the second nozzle outlets such that discharged streams of the second liquid from the second nozzle outlets impinge upon the discharged stream of the first liquid from the first nozzle outlet;
c. storing a quantity of the first liquid in the first reservoir and a quantity of the second liquid in the second reservoir; and
d. simultaneously supplying the stored first liquid to the first nozzle inlet and the stored second liquid to the second nozzle inlet under pressure for discharge from the first nozzle outlet and the second nozzle outlets, respectively.

6. A method in accordance with claim 5, wherein one of the liquids is edible oil and one of the liquids is an aqueous solution.

7. A method in accordance with claim 6, wherein one of the liquids comprises olive oil and one of the liquids comprises vinegar.

8. A method in accordance with claim 5, wherein one of the liquids comprises a polysaccharide and one of the liquids comprises a polysaccharide cross-linking agent.

9. A method in accordance with claim 5, wherein one of the liquids comprises alginate and one of the liquids comprises calcium.

10. A method in accordance with claim 5, wherein one of the liquids comprises chitosan and one of the liquids comprises sodium tripolyphosphate.

11. A method in accordance with claim 5, wherein one of the liquids comprises an aqueous protein solution and one of the liquids comprises a protein cross-linking agent.

12. A method in accordance with claim 11, wherein one of the liquids comprises an aqueous albumin solution and one of the liquids comprises an aldehyde.

13. A method in accordance with claim 5, wherein one of the liquids comprises a blowing agent and one of the liquids comprises an acid reactable on contact with the blowing agent sufficient to evolve a gas.

14. (canceled)

15. A method in accordance with claim 5, wherein the dispensed liquids are normally immiscible.

16. A method in accordance with claim 5, wherein the dispensed liquids are chemically reactive.

17. A method in accordance with claim 5, wherein one of the liquids comprises fibrinogen and one of the liquids comprises thrombin.

18. An apparatus as in claim 1, comprising an activation mechanism operatively coupled to the first valve and the second valve, wherein the first valve and the second valve are simultaneously moved to the open position when the activation mechanism moves from a normal position to a discharge position.

19. An apparatus as in claim 3, comprising an activation mechanism operatively coupled to the first pressurization mechanism and the second pressurization mechanism, wherein the first pressurization mechanism provides pressure to the first liquid and the second pressurization mechanism provides pressure to the second liquid simultaneously when the activation mechanism moves from a normal position to a discharge position.

20. An apparatus as in claim 1, comprising a non-slip coating upon the outer surface of the first and second reservoirs.

21. An apparatus as in claim 1, comprising a pump to introduce atmospheric air as a propellant gas into the first and second reservoirs.
